(19) United States
(12) Patent Application Publication
(10) Pub. No.: US 2013/0238828 A1
(43) Pub. Date: Sep. 12, 2013

(54) Expansion card with both PCI slot and PCIe slot

(71) Applicant: Heng-Sheng Lin, New Taipei (TW)

(72) Inventor: Heng-Sheng Lin, New Taipei (TW)

(21) Appl. No.: 13/417,331

(22) Filed: Mar. 12, 2012

(51) Int. Cl. G06F 13/00

(52) U.S. Cl. 710/301

(57) ABSTRACT

An expansion card is provided with a PCB; a PCI slot disposed on the PCB, two connectors disposed on an edge of the PCB, each connector including a plurality of contacts; and a PCIe slot disposed on the PCB. Both the PCI slot and the PCIe slot are electrically connected to the contacts. The expansion card can be connected to a compact computer motherboard.

### BACKGROUND OF THE INVENTION

1. Field of the Invention

The invention relates to expansion cards of computer motherboard and more particularly to an expansion card having both PCI slot and PCIe slot mounted thereon.

2. Description of Related Art

The primary purpose of an expansion card is to provide or expand on features not offered by a computer motherboard. For example, original IBM PC did not provide graphics capability. In that case, a graphics card provided graphics capability can be attached to the motherboard.

Edge connectors are commonly used in personal computers for connecting expansion cards and computer memory to the system bus. Example expansion peripheral technologies which use edge connectors include PCI (Peripheral Component Interconnect) and PCI Express (abbreviated as PCIe).

However, a motherboard is required to have both a PCI slot and a PCIe slot so that a PCI card may fit into the PCI slot and a PCIe card may fit into the PCIe slot respectively. This inevitably can reduce available area of the motherboard and in turn it can reduce the expansibility of the motherboard. This is not desired because features including lightweight and compactness are always sought by the computer industry. Thus, the need for improvement still exists.

### SUMMARY OF THE INVENTION

It is therefore one object of the invention to provide an expansion card comprising a printed circuit board (PCB); a PCI slot disposed on the PCB; two connectors disposed on an edge of the PCB, each connector including a plurality of contacts; and a PCIe slot disposed on the PCB, wherein both the PCI slot and the PCIe slot are electrically connected to the contacts.

The above and other objects, features and advantages of the invention will become apparent from the following detailed description taken with the accompanying drawings.

### BRIEF DESCRIPTION OF THE DRAWINGS

FIG. 1 is a perspective view of an expansion card according to the invention; and

FIG. 2 is a perspective view of the expansion card attached to a computer motherboard.

### DETAILED DESCRIPTION OF THE INVENTION

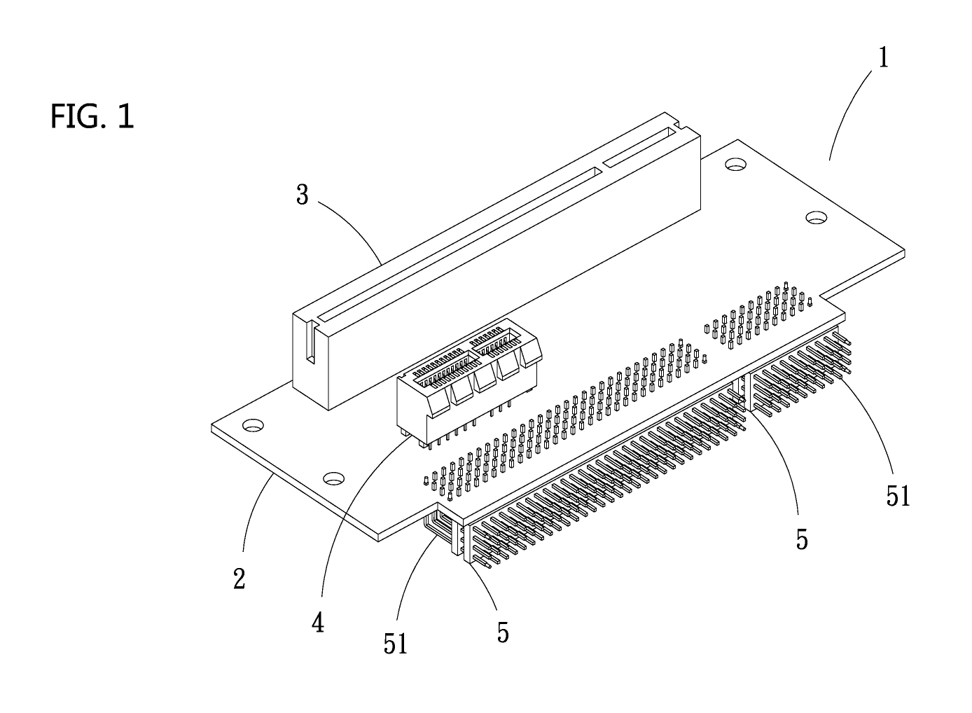

Referring to FIG. 1, an expansion card 1 in accordance with the invention comprises the following components as discussed in detail below.

A printed circuit board (PCB) 2 is provided. A PCI slot 3 is provided along one edge of the PCB 2. Two connectors 5 are provided on the opposite other edge of the PCB 2. Each connector 5 has a plurality of contacts (i.e., pins) 51 shaped as an L. A PCIe slot 4 is provided between the PCI slot 3 and the connectors 5. Both the PCI slot 3 and the PCIe slot 4 are electrically connected to the pins 51.

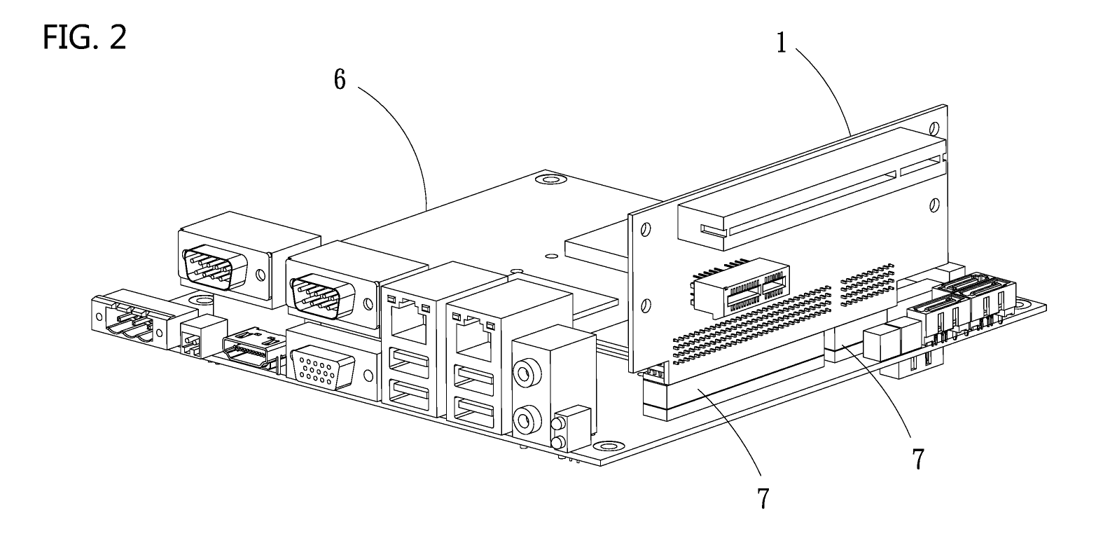

Referring to FIG. 2 in conjunction with FIG. 1, a computer motherboard 6 is shown. Two expansion slots 5 are provided adjacent to one edge of the motherboard 6. The pins 51 of both connectors 5 can fit into the expansion slots 5 respectively.

It is envisaged by the invention that the expansion card connected to a compact computer motherboard can be carried out.

While the invention has been described in terms of preferred embodiments, those skilled in the art will recognize that the invention can be practiced with modifications within the spirit and scope of the appended claims.

What is claimed is:

1. An expansion card comprising:
a PCB (printed circuit board);
a PCI (Peripheral Component Interconnect) slot disposed on the PCB;
two connectors disposed on an edge of the PCB, each connector including a plurality of contacts; and
a PCIe (Peripheral Component Interconnect Express) slot disposed on the PCB,
wherein both the PCI slot and the PCIe slot are electrically connected to the contacts.
